(19) United States
(12) Patent Application Publication
(10) Pub. No.: US 2006/0243215 A1
(43) Pub. Date: Nov. 2, 2006

(54) Pet house

(76) Inventor: Chan Hsiang Ho, Taipei (TW)

Correspondence Address: CHAN HSIANG HO, P.O. BOX 24-108, TAIPEI, TW

(21) Appl. No.: 11/117,750

(22) Filed: Apr. 29, 2005

(51) Int. Cl. A01K 31/06

(52) U.S. Cl. 119/455

(57) ABSTRACT

A pet house formed of multiple pet house units detachably fastened to one another through a plug joint, each pet house unit being formed of a house and an ornamental storage item secured to the inside of the house with hook and loop materials, the house having a body with window openings, ornamental plate members detachably coupled to the window openings, a rood covering the body, a LED mounted inside the roof, and a switch for switching on/off the LED.

### BACKGROUND OF THE INVENTION

1. Field of the Invention

The present invention relates to pet houses and more particularly, to a combination pet house that can conveniently be built up by the user, and is practical for showing personal storage items.

2. Description of the Related Art

People may have the hobbit of collecting small ornamental items and playing with the collected small ornamental items for fun. Further, people may directly put collected small ornamental items such as animal models, matchbox cars, jewels, stones, cigarette lighters, etc. in a cabinet or storage box. Simply putting storage items in a cabinet cannot show the sense of beauty of the storage items.

### SUMMARY OF THE INVENTION

The present invention has been accomplished under the circumstances in view. According to one aspect of the present invention, the combination pet house comprises at least one toy house unit. Each pet house unit comprises a building, at least one pet storage item, and hook and loop materials adapted to secure the at least one pet storage item to the inside of the building. The building comprises a body, which has a plurality of window openings, and a roof for covering said body.

According to another aspect of the present invention, the building of each pet house unit further comprises a light emitting diode installed in the roof thereof on the inside, switch means adapted to switch on/off said light emitting diode, two vertical sliding grooves bilaterally disposed in each of the window openings of the body thereof, and at least one ornamental plate member insertable into the vertical sliding grooves in each of the window openings.

According to still another aspect of the present invention, the building of each pet house unit comprises a plurality of coupling holes at the bottom side of the body thereof and a plurality of coupling rods at the top side thereof. The coupling holes and the coupling rods are so arranged that plugging the coupling rods of one of the pet house units into the coupling holes of another of the pet house units build up the combination pet house.

### BRIEF DESCRIPTION OF THE DRAWINGS

FIG. 1 is an exploded view of a house unit for combination pet house according to the present invention.

FIG. 2 is an exploded view of one combination example of the combination pet house according to the present invention.

FIG. 3 is an elevational view of another combination example of the combination pet house according to present invention.

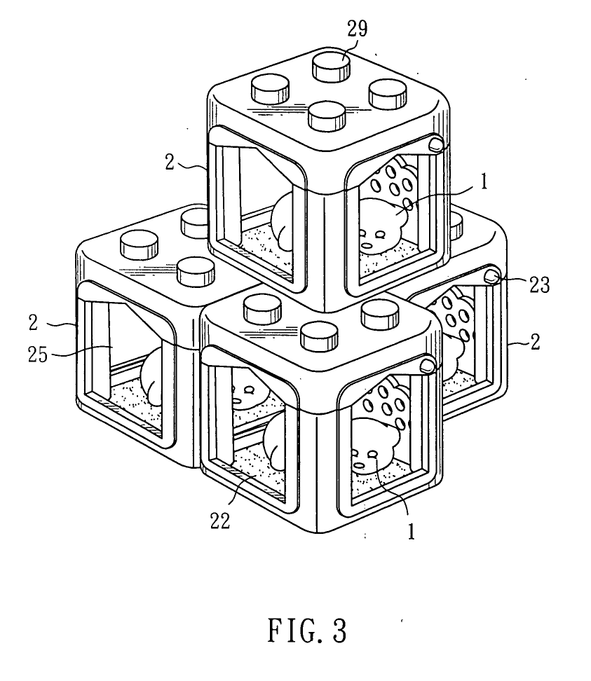

FIG. 4 is an elevational view of still another combination example of the combination pet house according to the present invention.

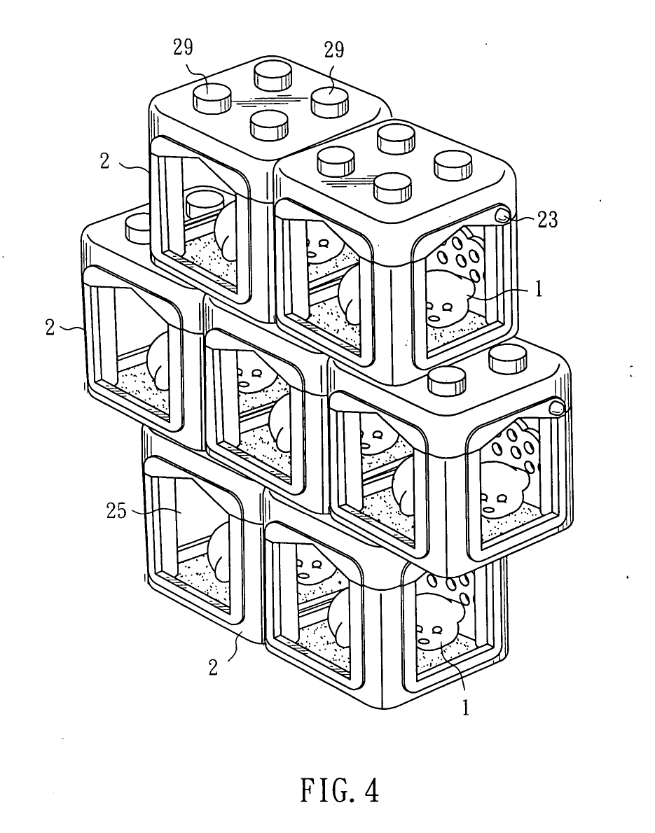

### DETAILED DESCRIPTION OF THE PREFERRED EMBODIMENT

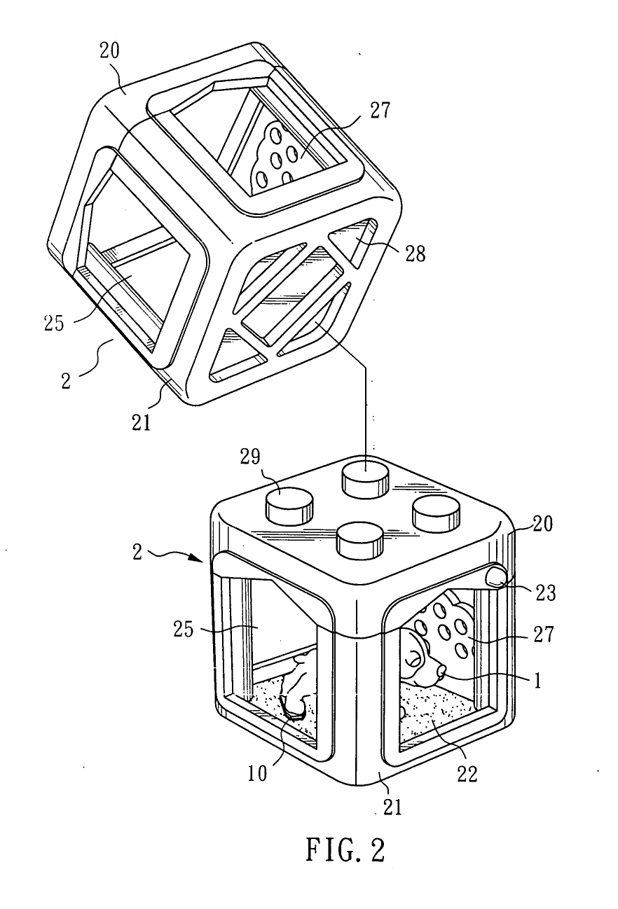

Referring to FIGS. 2˜4, a combination pet house in accordance with the present invention is shown comprised of a plurality of pet house units detachably fastened to one another.

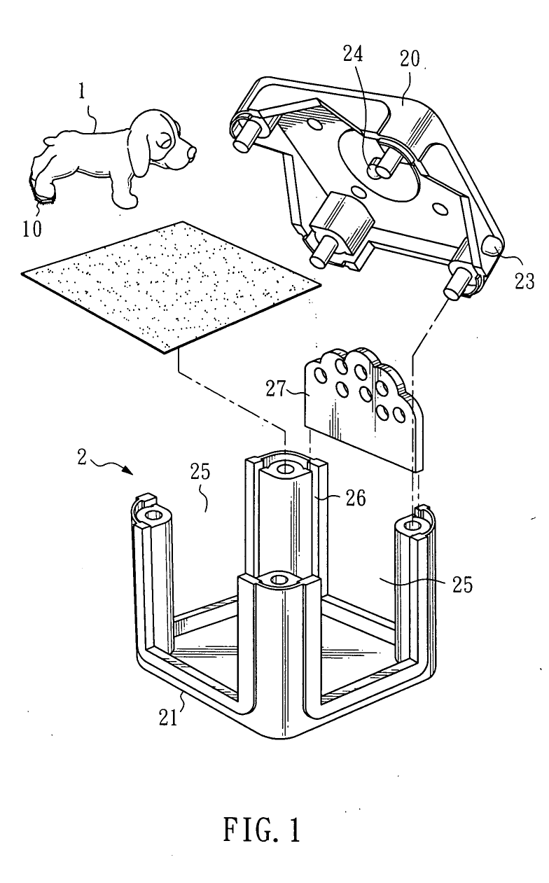

Referring to FIG. 1, the aforesaid pet house units each comprise an ornamental storage item 1 and a building 2. The ornamental storage item 1 can be an animal model, matchbox car, jewels, stone, cigarette lighter, or any of a variety of miniature toys or personal items, having a fastening device, for example, pads of hoop material 10 fixedly provided at the bottom side. The building 2 comprises a body 21, which has a window opening 25 at each of the peripheral sides thereof and two sliding grooves 26 bilaterally arranged in parallel in each window opening 25, a roof 20 detachably fastened to the body 21 at the top (through, for example, a plug joint), a light source, for example, a LED (light emitting diode) 24 installed in the roof 20 at the bottom side, an on/off switch 23 installed in the roof 20 at LED 24, a fastening device, for example, a pad of hook material 22 provided inside the body 21, and at least one ornamental plate member 27 respectively fastened to the sliding grooves 26 in each window opening 25. The ornamental plate member 27 can be a door panel, window panel, grille, or the like.

Referring to FIGS. 1 and 2 again, during assembly process, the at least one ornamental plate member 27 is respectively fastened to the sliding grooves 26 in each window opening 25, and then the ornamental storage item 1 is put in the body 21 to have the pads of loop material 10 be fastened to the pad of hook material 22, and then the roof 20 is covered on the body 21. When switched on the on/off switch 23, the LED 24 is turned on to give off light, illuminating the ornamental storage item 1.

Referring to FIGS. 1˜4 again, each pet house unit has bottom coupling holes 28 at the bottom side of the body 21 and top coupling rods 29 at the top side of the roof 20. By engaging the top coupling rods 29 of one pet house unit to the bottom coupling holes 28 of another pet house unit, a plurality of pet house units are arranged together, thereby forming a combination pet house.

Although a particular embodiment of the invention has been described in detail for purposes of illustration, various modifications and enhancements may be made without departing from the spirit and scope of the invention.

What the invention claimed is:

1. A pet house comprising at least one pet house unit, said at least one pet house unit each comprising a building, at least one pet storage item, and hook and loop materials adapted to secure said at least one pet storage item to the inside of said building, said building comprising a body, said body having a plurality of window openings, and a roof for covering said body.

2. The pet house as claimed in claim 1, wherein the building of each said pet house unit further comprises a light emitting diode installed in the roof thereof on the inside, and switch means adapted to switch on/off said light emitting diode.

3. The pet house as claimed in claim 1, wherein the building of each said pet house unit further comprises two vertical sliding grooves bilaterally disposed in each of the window openings of the body thereof, and at least one ornamental plate member insertable into the vertical sliding grooves in each of said window openings.

4. The pet house as claimed in claim 1, wherein the building of each of said pet house units comprises a plurality of coupling holes at a bottom side of the body thereof and a plurality of coupling rods at a top side thereof, said coupling holes and said coupling rods being so arranged that plugging the coupling rods of one of said pet house units into the coupling holes of another of said pet house units build up the combination pet house.
